(19) United States
(12) Patent Application Publication
(10) Pub. No.: US 2012/0113117 A1
(43) Pub. Date: May 10, 2012

(54) IMAGE PROCESSING APPARATUS, IMAGE PROCESSING METHOD, AND COMPUTER PROGRAM PRODUCT THEREOF

(76) Inventors: Io Nakayama, Kanagawa (JP); Masahiro Baba, Kanagawa (JP); Kenichi Shimoyama, Tokyo (JP); Takeshi Mita, Kanagawa (JP)

(21) Appl. No.: 13/069,681

(22) Filed: Mar. 23, 2011

(30) Foreign Application Priority Data
Nov. 10, 2010 (JP) 2010-252372

(51) Int. Cl. G06T 17/00

(52) U.S. Cl. 345/420

(57) ABSTRACT

According to an embodiment, an image processing apparatus includes a detecting unit configured to detect at least one object included in an image; a selecting unit configured to select a depth model to be a base of information about depth of the object in accordance with a property of the object; a segment unit configured to segment an area of the object detected from the image; and a depth map creating unit configured to create a depth map representing a depth of the image. The depth map creating unit arranges the depth model at a position on the depth map corresponding to a position of the segmented area of the object in the image, compares an area of the depth model and the area of the object, and gives a corrected depth value to a position not superimposed on other.

### CROSS-REFERENCE TO RELATED APPLICATIONS

This application is based upon and claims the benefit of priority from Japanese Patent Application No. 2010-252372, filed on Nov. 10, 2010; the entire contents of which are incorporated herein by reference.

### FIELD

Embodiments described herein relate generally to an image processing apparatus, an image processing method, and a computer program product.

### BACKGROUND

Conventionally, to display a two-dimensional image three-dimensionally, there are technologies of adding information about depth to the two-dimensional image. According to one of the conventional technologies, for example, from a distribution of high-frequency components in an upper part and a lower part of a two-dimensional image, a composition ratio to a depth model that is preliminarily prepared is calculated, and a rough depth of the whole of the image is obtained from a result of the calculation. Moreover, it is proposed that the depth is to be corrected by superimposing a red color signal (R signal) in a two-dimensional image onto a rough depth.

### BRIEF DESCRIPTION OF THE DRAWINGS

FIG. 1 is a schematic configuration diagram of an image processing apparatus according to a first embodiment;

FIG. 2 is a schematic diagram that depicts an example of a depth map creating unit according to the first embodiment;

FIG. 3 is a flowchart that depicts a flow in outline of an image processing method according to the first embodiment;

FIG. 4 is a schematic diagram that depicts a flow when creating a depth map about an input image;

FIG. 5 is an enlarged view of a section (f) in FIG. 4;

FIG. 6 is a schematic diagram that depicts an example of a depth map creating unit according to a modification 1 of the first embodiment;

FIG. 7 is a flowchart that depicts a flow in outline of an image processing method according to the modification 1;

FIG. 8 is a schematic diagram that depicts a flow when creating a depth map about an input image;

FIG. 9 is a schematic configuration diagram of an image processing apparatus according to a second embodiment;

FIG. 10 is a flowchart that depicts a flow in outline of an image processing method according to the second embodiment;

FIG. 11 is a schematic diagram that depicts a flow when creating a depth map about an input image;

FIG. 12 is a schematic configuration diagram of an image processing apparatus according to a third embodiment;

FIG. 13 is a flowchart that depicts a flow in outline of an image processing method according to the third embodiment; and

FIG. 14 is a schematic diagram that depicts a flow when creating a depth model about an input image.

### DETAILED DESCRIPTION

According to one embodiment, an image processing apparatus includes a detecting unit configured to detect at least one object included in an image; a selecting unit configured to select a depth model to be a base of information about depth of the object in accordance with a property of the object; a segment unit configured to segment an area of the object detected from the image; and a depth map creating unit configured to create a depth map representing a depth of the image. The depth map creating unit arranges the depth model at a position on the depth map corresponding to a position of the segmented area of the object in the image, compares an area of the depth model and the area of the object, and gives a corrected depth value to a position not superimposed on other.

Various embodiments will be described hereinafter with reference to the accompanying drawings.

### First Embodiment

First of all, an image processing apparatus, an image processing method, and a computer program product thereof according to a first embodiment are explained below in detail with reference to the drawings. Explanations described below assume the following items (1) to (4). However, the present disclosure is not limited by these items.

(1) It is assumed that an upper left corner of the image is to be the origin, the traverse direction (horizontal direction) is an x axis, and the longitudinal direction (vertical direction) is a y axis. However, a coordinate system to be set about an image is not limited to this. A pixel value at coordinates (x, y) in the image is expressed as P(x, y). A pixel value P that indicates the brightness or a color component of a pixel is acceptable. For example, brightness, lightness, and specific color channel are applicable to such pixel value P.

(2) The depth map is data that represents depth of each pixel in an image. The depth map has the origin at the upper left corner of the map, the x axis in the traverse direction (horizontal direction), and the y axis in the longitudinal direction (vertical direction). However, a coordinate system to be set about the depth map is not limited to this. A pixel value at coordinates (X, Y) on the depth map is expressed as Z(X, Y). The pixel value Z is information indicating the depth of each pixel (depth information). For example, the larger the pixel value Z, the farther the depth of the pixel is.

(3) Coordinates on an image correspond to coordinates on a depth map one to one. According to the present disclosure, unless otherwise specifically described, the size of an image is equal to the size of a depth map. Moreover, coordinates (x, y) on an image and coordinates (X, Y) on a depth map correspond to each other. In other words, x=X, and y=Y are held.

(4) Unless otherwise specifically described in the present disclosure, the pixel value P on an image is to be described as “pixel value”, and a range of the value is [0, 255] (between 0 and 255). Furthermore, the pixel value Z on a depth map is to be described as “depth value”, and a range of the value is [0, 255] (between 0 and 255).

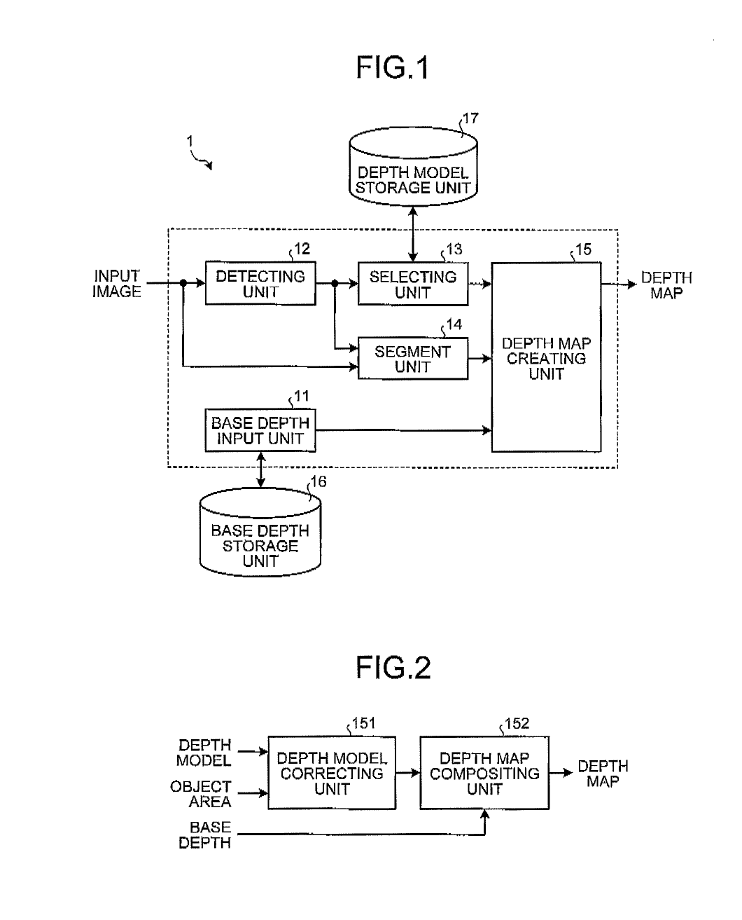

Next, an image processing apparatus 1 according to the first embodiment is explained below in detail with reference to the drawings. FIG. 1 is a schematic configuration diagram of the image processing apparatus 1 according to the first embodiment. As shown in FIG. 1, the image processing apparatus 1 includes a base depth input unit 11, a detecting unit 12, a selecting unit 13, a segment unit 14, and a depth map creating unit 15. The image processing apparatus 1 can further include a base depth storage unit 16, and a depth model storage unit 17.

Into the image processing apparatus 1, a two-dimensional image is input (hereinafter, “input image”). Any device or any medium can be applied to an input source of an input image. For example, it is preferable that input data can be input from a recording medium, such as a Hard Disk Drive (HDD), a Digital Versatile Disk Read-Only Memory (DVD-ROM), or a flash memory. Moreover, it is preferable that input data can be input from an external device connected via a network, such as a video recorder, a digital camera, or a digital video camera. Furthermore, into the image processing apparatus 1, image data can be input from a receiver that receives television broadcasting via wireless or wired communication.

Furthermore, the format of an input image 100 is not necessarily a two-dimensional (2D) image. For example, input image 100 can be a stereoscopic image, such as a side-by-side format or a line-by-line format, or an image in multiple-viewpoint format. In such case, an image of one of the viewpoints is treated as an image to be processed.

The base depth input unit 11 receives a base depth that a depth value Z is set on each pixel in the whole of the map of the same size as the input image. The base depth is, for example, data of a three-dimensional spatial structure having depth. Depth information included in the base depth is expressed by numeric value per pixel (depth value Z), for example. Such base depth can be used as basic data of depth when creating the depth map about the input image. The base depth can be stored in the base depth storage unit 16. Preferably the base depth storage unit 16 preliminarily stores one or more patterns of base depths as templates. The base depth input unit 11 specifies a template of the base depth appropriate to the input image by analyzing the input image, and acquires the template from the base depth storage unit 16.

Specification of base depth can be performed based on a spatial structure that is specified or estimated from the input image. According to the specifying method, a spatial structure of the input image is specified or estimated from, for example, an area of the ground or the floor, or an area of the sky or the ceiling, in the input image. The base depth appropriate to the spatial structure is then specified from the base depth storage unit 16. However, not limited to the specifying method, the base depth can be acquired by using various methods.

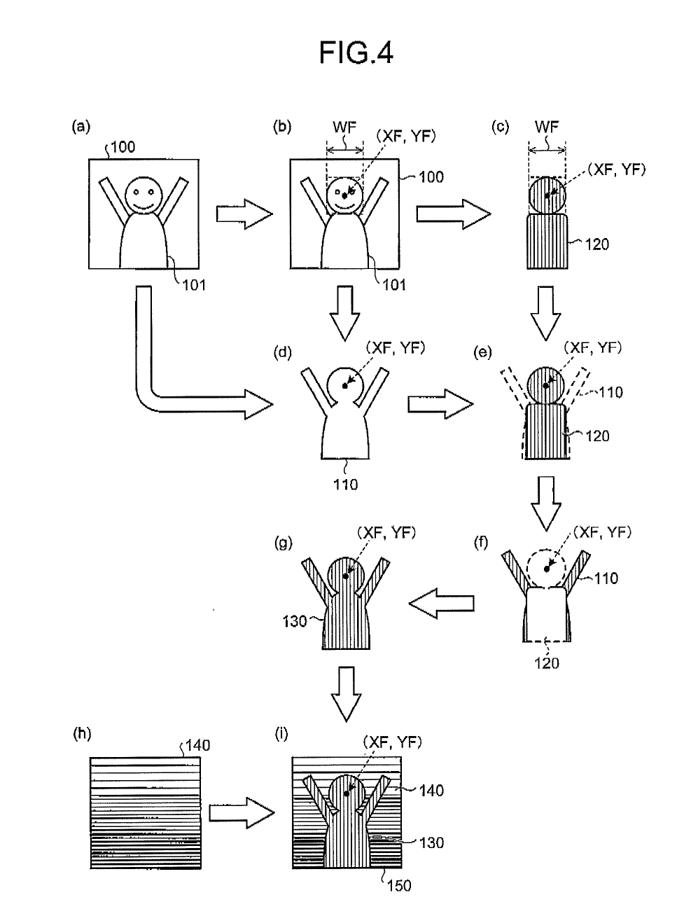

Not limited by this, the base depth of the depth value Z that is uniform overall can be used. In such case, the depth value Z to be set can be variously modified, for example, to a depth value Z indicating the farthest position, a depth value Z that is created at random provided it is larger than the maximum value of depth values Z of pixels in a corrected depth map described later (see a section (g) in FIG. 4), or the like.

The detecting unit 12 detects at least one object in the input image. Through detection of the object, the type of an object can be detected in addition to the position and the area of the object (shape, size, and the like). A generally known method can be used for the detection of object. Among existing detection methods, there is a method of classifying the object from the input image, for example, by using a classifier for object detection. However, not limited to this, various detection methods are applicable. The detecting unit 12 can detect segmented object areas that the object is segmented into a plurality of areas. For example, a method of segmenting the object into units of object is conceivable.

The selecting unit 13 selects at least one depth model corresponding to the object detected by the detecting unit 12 (hereinafter, “detected object”), from a group of depth models that is an aggregation of a plurality of depth models. The depth model is a model preliminarily made from depth information about each object. According to the depth model, for example, a stereoscopic shape viewing from one direction of an object, such as a person, an animal, a conveyance, a building, a plant, or the like is expressed in information about depth. Moreover, the group of depth models includes depth models in various shapes about an individual object, in addition to depth models of various kinds of objects. The group of depth models is stored, for example, by the depth model storage unit 17.

The segment unit 14 segments an area of the detected object (hereinafter, “object area”) from the input image. For example, the segment unit 14 can segment the object area from the input image by setting a flag in the object area. The depth map creating unit 15 creates a depth map indicating information about depth of the input image, from a base depth, a depth model, and an object area. An example of the depth map creating unit 15 is shown in FIG. 2.

As shown in FIG. 2, the depth map creating unit 15 includes a depth model correcting unit 151 and a depth map compositing unit 152. The depth model correcting unit 151 corrects a depth model selected by the selecting unit 13 based on the object area created by the segment unit 14. Details of correction will be mentioned later. Hereinafter, a depth model after correction is referred to as a corrected depth model. The depth map compositing unit 152 creates one depth map to be given to the input image by combining a corrected depth model created by the depth model correcting unit 151 and the base depth received by the base depth input unit 11.

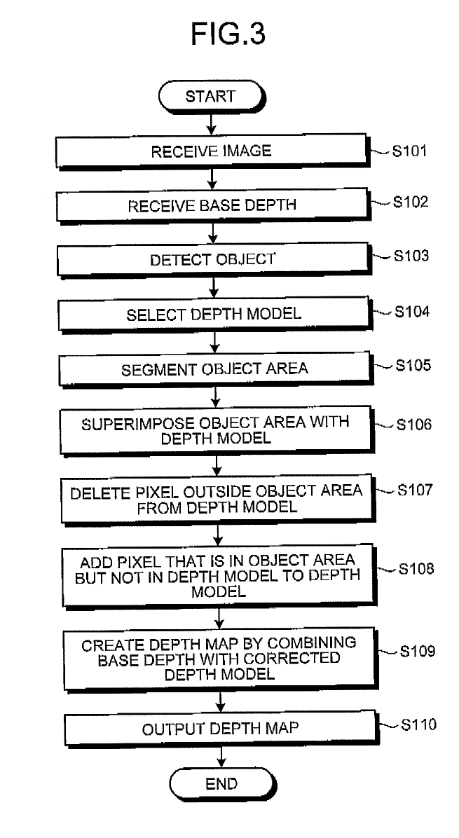

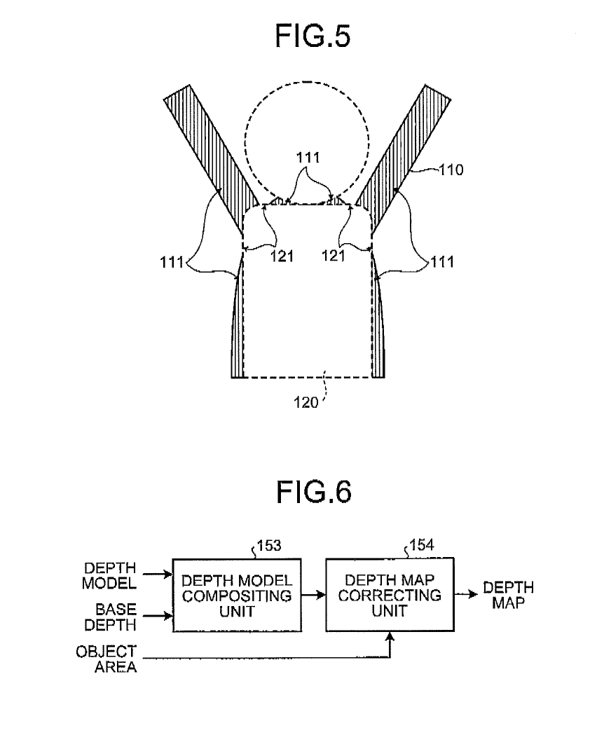

A flow of an image processing method to be executed by the image processing apparatus 1 is explained below in detail with reference to the drawings. FIG. 3 is a flowchart that depicts a flow in outline of an image processing method according to the first embodiment. FIG. 4 is a schematic diagram that depicts a flow when creating the depth map about the input image. FIG. 5 is an enlarged view of a section (f) in FIG. 4. The following explanation explains along the flowchart in FIG. 3, appropriately referring to FIGS. 4 and 5. Moreover, the following explanation refers to a case where the input image includes one person, as an example. However, not limited to a person, any object can be a target, such as a person, an animal, a conveyance, a building, a plant, or the like, of which creation of a depth model and segmentation of an object area from an image are available. Moreover, the first embodiment can be applied to a case where there is a plurality of objects in a two-dimensional image, or a case where there is a plurality of kinds of objects.

As shown in FIG. 3, according to the image processing method, a two-dimensional image is input into the image processing apparatus 1 from the outside (Step S101). An example of the input image is shown in a section (a) in FIG. 4. As shown in the section (a) in FIG. 4, suppose one person is shown as an object 101 on the input image 100. The input image 100 is input into, for example, the detecting unit 12 and the segment unit 14.

When the input image 100 is input, the base depth input unit 11 receives the base depth to be added to the input image 100 (Step S102). As the base depth to be received, the base depth with a depth structure that is the closest to a spatial structure estimated from, for example, a sky area or a ground area in the input image 100 can be selected from a plurality of templates stored by the base depth storage unit 16. An example of a base depth 140 thus received is shown in a section (h) in FIG. 4. FIG. 4 depicts that the denser hatching, the closer the depth is.

The detecting unit 12 detects object information indicating the property of the object 101 shown on the input image 100, by analyzing the input image 100 (Step S103). The object information is, for example, the position (for example, reference coordinates), the area (shape, size, and the like), the type, and the like, of the object 101. When the input image 100 includes a plurality of objects, object information is detected with respect to each of the objects. A general method can be used for detection of object. For example, when the object 101 is a person, a method of face detection or personal detection can be used. As shown in a section (b) in FIG. 4, a case where central coordinates (XF, YF) of a face and a width WF of the face in the input image 100 are obtained as object information through face detection is shown. The central coordinates (XF, YF) detected with respect to the object 101 are treated as reference coordinates of the object 101. When there is a plurality of objects in the input image 100, it is preferable to create object information with respect to each of detected objects, and to store them together into a not-shown memory.

Object information about the object 101 is input into the selecting unit 13. The selecting unit 13 selects a depth model appropriate to the object 101 from a group of depth models in the depth model storage unit 17, based on the object information (e.g. the shape and the type) (Step S104).

B A section (c) in FIG. 4 depicts an example of a depth model 120 selected from the object information about the object 101. As shown in the section (c) in FIG. 4, with respect to the selected depth model 120, the reference coordinates (XF, YF) are set at a position corresponding to the central coordinates (XF, YF) of the object 101. The size of a depth model to be selected is not necessarily to be close to the size of the object area. When the size of the selected depth model is different from the size of the object area, the depth model can be enlarged or reduced in size, based on the size in the object information. According to the example shown in the section (c) in FIG. 4, the depth model is to be enlarged or to be reduced in size, so as to match with the width WF in the object information. When there is a plurality of objects in the input image 100, the selecting unit 13 selects a depth model with respect to each of individual objects, and sets a position and a size on each of the selected depth models. In such case, preferably the selecting unit 13 selects a plurality of depth models, and stores them together as a group of depth models into the not-shown memory.

The object information is also input into the segment unit 14, as described above. The segment unit 14 segments the area of the object 101 (object area) from the input image 100 based on the object information (Step S105). A general segmentation technology can be used for segmentation of the object area. An example of a segmented an object area 110 is shown in a section (d) in FIG. 4. As shown in the section (d) in FIG. 4, for example, in a case where the object is a person, the object area 110 including its arms and legs, and a hat can be segmented, by using the segmentation technology. In the segmented object area 110, the reference coordinates (XF, YF) are set at a position corresponding to the central coordinates (XF, YF) of the object 101. It is acceptable on condition that the object area 110 includes at least information about contours of the object 101. When there is a plurality of objects in the input image 100, it is preferable to segment the object area with respect to each of detected objects, and to store them together into the not-shown memory as a group of object area. Furthermore, the segment unit 14 can use a segment area that is manually input in advance with respect to the object 101, as the object area 110.

The selected depth model 120 and the segmented object area 110 are input into the depth map creating unit 15. In the depth map creating unit 15, to begin with, the depth model correcting unit 151 superimposes the depth model 120 and the object area 110 that are input (Step S106). As shown in a section (e) in FIG. 4, the depth model 120 and the object area 110 are superimposed so as to match the reference coordinates (XF, YF) set in the depth model 120 with the reference coordinates (XF, YF) set in the object area 110.

Subsequently, as shown in a section (f) in FIG. 4, the depth model correcting unit 151 deletes pixels positioned outside the object area 110 from the depth model 120 (Step S107); and adds pixels in the object area 110 but not in the depth model 120 to the depth model 120 (Step S108), thereby correcting the depth model 120. Correction of the depth model 120 is explained below with reference to FIG. 5, which is an enlarged view of the section (f) in FIG. 4. According to the correction, as shown in FIG. 5, pixels in areas 121 only of the depth model 120 is deleted (Step S107), and pixels are added into areas 111 only of the object area 110 (Step S108). The depth value Z of a pixel to be added can be set to a value, for example, as described below. However, it is not limited to the values described below as an example, and can be modified in any form on condition that the depth value can add a depth value to a pixel without or with little of feeling of strangeness when visually displaying a corrected depth model. The vicinity in the following description indicates an area within, for example, few pixels to tens pixels around a certain position.

(1) A depth value Z of a pixel in the depth model 120 at a position nearest to the position of a pixel to be added (correction position)

(2) An average of depth values Z of n pixels (n is a natural number) in the depth model 120 and in the vicinity of the position nearest to the position of the pixel that is to be added (correction position)

(3) The maximum value of depth values Z of n pixels in the depth model 120 and in the vicinity of the position nearest to the position of the pixel that is to be added

(4) The maximum value of depth values Z of pixels in the depth model 120

By performing the correction of the depth model as described above, a corrected depth model 130 as shown in a section (g) in FIG. 4 is created. The corrected depth model 130 is input into the depth map compositing unit 152. The base depth 140 (the section (h) in FIG. 4) is also input from the base depth input unit 11 into the depth map compositing unit 152, as described above (Step S102).

The depth map compositing unit 152 creates a depth map 150 about the input image 100, as shown in a section (i) in FIG. 4, by combining the base depth 140 and the corrected depth model 130, on the basis of the coordinate system of the base depth 140 and the reference coordinates (XF, YF) of the corrected depth model 130 (Step S109). Through the composition of the base depth 140 and the corrected depth model 130, pixels in the base depth 140 are replaced with pixels in the corrected depth model 130. However, not limited to this, for example, among corresponding pixels between the base depth 140 and the corrected depth model 130, the depth value Z of a pixel located closer to the front, i.e., a pixel with a smaller depth value Z can be used.

The depth map 150 created in this way as described above is output from the depth map creating unit 15 to a certain external device, such as a display device (Step S110). Accordingly, the image processing method of creating the depth map 150 about the input image 100 is finished.

As described above, according to the first embodiment, even when the shape of an object, such as a person, in a two-dimensional image is different from a depth model prepared in advance, a depth model more precise to the object can be created. As a result, a structure (depth map) with more accurate depth can be created from a two-dimensional image.

Moreover, based on a depth created according to the first embodiment, by obtaining disparity of each pixel in the input image 100 an image that is observed from another view point different from the input image 100 can be created. Therefore, multiple-viewpoint images that are observed from two or more view points are created from the input image 100, and displayed on a stereoscopic image display, thereby enabling stereoscopic vision. The image that is observed from another view point can be created, for example, by rendering technology.

Modification 1 of Depth Map Creating Unit

In the first embodiment, the corrected depth model 130 more precise to an object is created by correcting the depth model 120 that is selected for the object 101, based on the object area 110. However, not limited by this, a similar effect can be obtained, for example, by correcting the depth of the object 101 based on the object area 110, after adding the depth model 120 to the object 101 in the input image 100. In such case, the depth map creating unit 15 in FIG. 1 is configured, for example, as shown in FIG. 6.

As shown in FIG. 6, the depth map creating unit 15 according to a modification 1 of the first embodiment includes a depth model compositing unit 153 and a depth map correcting unit 154. Into the depth model compositing unit 153, the depth model 120 output from the selecting unit 13, and the base depth 140 output from the base depth input unit 11 are input. The depth model compositing unit 153 creates a pre-depth map by combining the base depth 140 and the depth model 120. Into the depth map correcting unit 154, the object area 110 and the pre-depth map are input. The depth map correcting unit 154 corrects the depth model 120 in the pre-depth map based on the object area 110. Accordingly, the depth map 150 that substantially the base depth 140 is combined with the corrected depth model 130 is created.

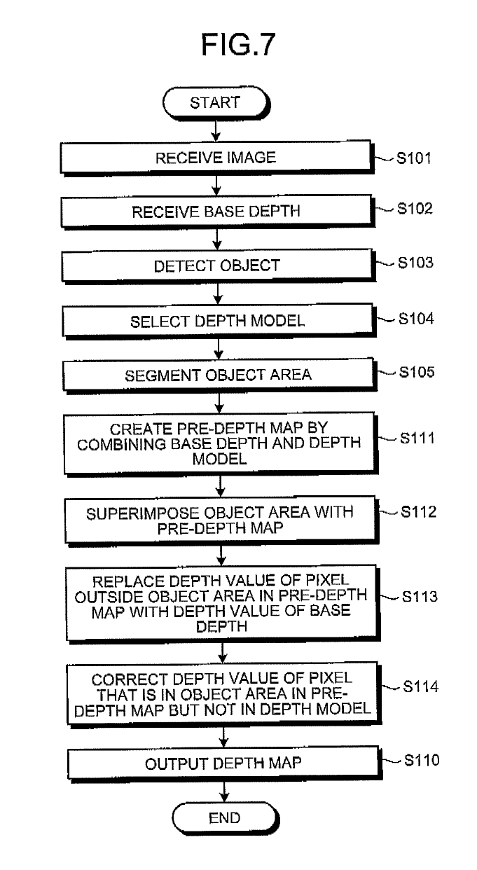

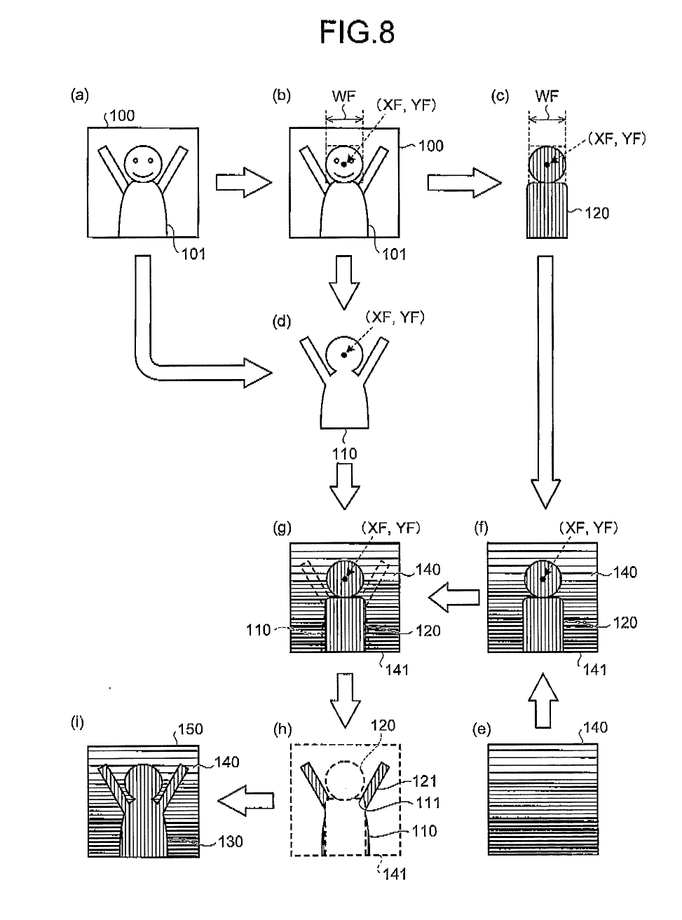

A flow of an image processing method according to the modification 1 is then explained below in detail with reference to the drawings. FIG. 7 is a flowchart that depicts a flow in outline of an image processing method according to the modification 1. FIG. 8 is a schematic diagram that depicts a flow when creating the depth map about an input image. In the following explanation, a configuration similar to the first embodiment is appropriately compared and chosen.

As shown in FIG. 7, according to the image processing method according to the modification 1, through processes similar to the processes shown at Steps S101 to S105 in FIG. 3, the base depth 140, the depth model 120, and the object area 110 are acquired (see a section (a) in FIG. 8 to a section (d) in FIG. 8, and a section (e) in FIG. 8). The base depth 140, the depth model 120, and the object area 110 are input into the depth map creating unit 15 as described above.

According to the modification 1, the depth model compositing unit 153 of the depth map creating unit 15 then combines the base depth 140 and the depth model 120, based on the coordinate system of the base depth 140, and the reference coordinates (XF, YF) of the depth model 120 (Step S111). Accordingly, as shown in a section (f) in FIG. 8, a pre-depth map 141 that the base depth 140 is superimposed with the depth model 120 is created. A composition method of the base depth 140 and the corrected depth model 130 is similar to the above-described composition of the base depth 140 and the corrected depth model 130.

The pre-depth map 141 is input together with the object area 110 into the depth map correcting unit 154. As shown in a section (g) in FIG. 8, the depth map correcting unit 154 superimposes the object area 110 onto the pre-depth map 141, based on the coordinate system of the pre-depth map 141 and the reference coordinates (XF, YF) of the object area 110 (Step S112).

Subsequently, as shown in a section (h) in FIG. 8, the depth map correcting unit 154 replaces depth values Z of pixels outside the object area 110 in the pre-depth map 141 with depth values Z of corresponding pixels in the base depth 140 (Step S113), and corrects depth values Z of pixels in the object area 110 in the pre-depth map 141 but not in the depth model 120 (Step S114). Accordingly, the depth model 120 in the pre-depth map 141 is corrected to the corrected depth model 130, and as shown in a section (i) in FIG. 8, the depth map 150 that the base depth 140 is combined with the corrected depth model 130 is created. The depth value Z of a pixel to be corrected can be set similarly to the depth value Z of a pixel to be added at Step S108 in FIG. 3. The depth map 150 created in this way described above is output from the depth map creating unit 15 to a certain external device, such as a display device, similarly to Step S110 in FIG. 3. Accordingly, the image processing method of creating the depth map 150 about the input image 100 is finished.

As described above, by correcting the depth model 120 based on the object area 110 after giving the depth model 120 to the object 101 in the input image 100, an effect similar to the first embodiment can be obtained. The other configurations, operations, and effects are similar to those according to the first embodiment, therefore detailed explanations are omitted here.

### Second Embodiment

Next, an image processing apparatus, an image processing method, and a computer program product thereof according to a second embodiment are explained below in detail with reference to the drawings. In the following description, configurations similar to the first embodiment and its modification are assigned with the same reference numerals, and repeated explanations of them are omitted.

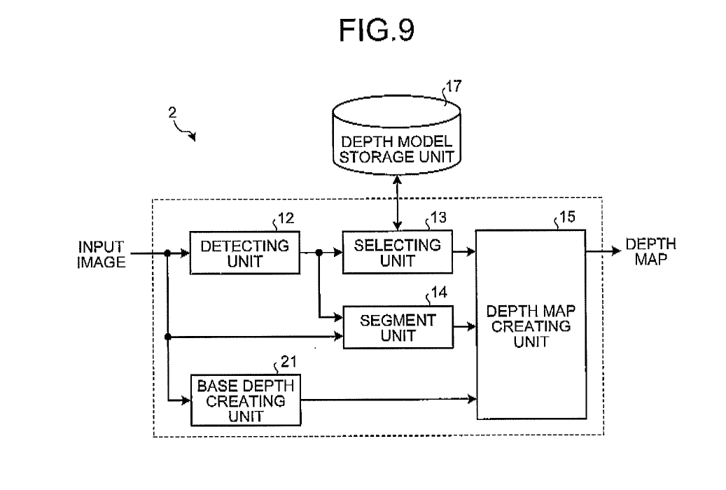

FIG. 9 is a schematic configuration diagram of an image processing apparatus 2 according to the second embodiment. As it is obvious by comparing FIG. 9 and FIG. 1, the image processing apparatus 2 (FIG. 9) includes a configuration similar to the image processing apparatus 1 (FIG. 1). However, in the image processing apparatus 2, the base depth input unit 11 in the image processing apparatus 1 is replaced with a base depth creating unit 21, and the base depth storage unit 16 is omitted.

An input image is input into the base depth creating unit 21. The base depth creating unit 21 creates a base depth from the input image. To create the base depth, a known technology can be used. However, as a technology to be used for creating the base depth, a technology of creating the base depth about the whole of an image by analyzing the composition of the image and motions of an object in the image is preferable. Therefore, the base depth creating unit 21 estimates or specifies a spatial structure of an input image from, for example, an area of the ground or the floor in the input image (hereinafter, “ground area”), or an area of the sky or the ceiling (hereinafter, “sky area”), and creates the base depth based on the estimated spatial structure. To detect the ground area and the sky area, a generally known method can be used. Among known detection methods, for example, there is a method by using a classifier with respect to each area. Moreover, another method by performing detection of two kinds of areas among three kinds of areas that are a three-dimensional object, the sky, and the ground in the input image, and determining the rest of the area as an area of the loft kind is conceivable. In such case, when categorizing areas into four or more kinds, one kind is to be left and the other kinds are to be detected. The base depth created by the base depth creating unit 21 is to be input into the depth map creating unit 15 and to be used for creation of the depth map, similarly to the first embodiment and its modification.

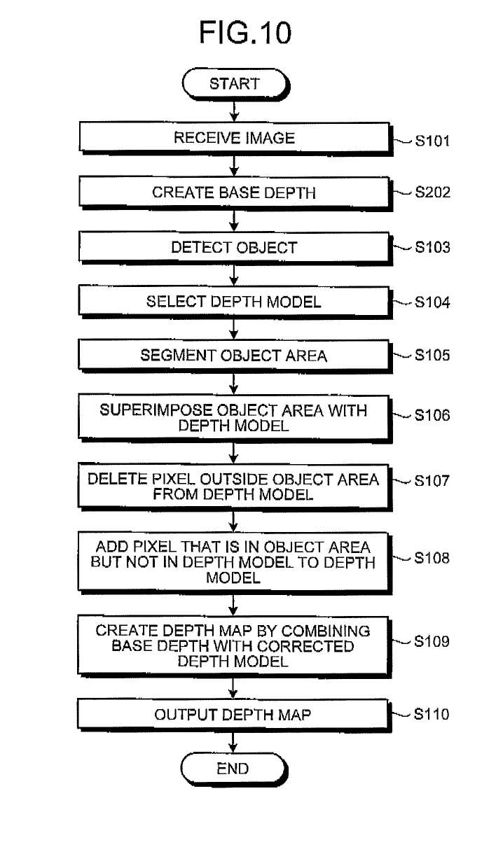

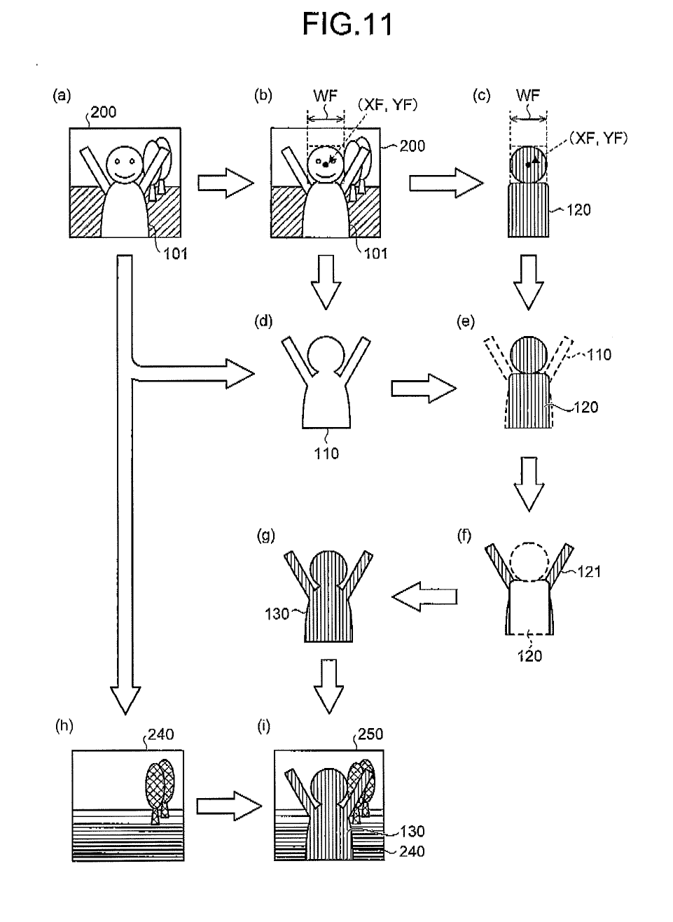

Then, a flow of an image processing method according to the second embodiment is explained below in detail with reference to the drawings. FIG. 10 is a flowchart that depicts a flow in outline of an image processing method according to the second embodiment. FIG. 11 is a schematic diagram that depicts a flow when creating the depth map about an input image. In the following explanation, a configuration similar to the first embodiment or its modification is appropriately compared and chosen.

As shown in FIG. 10, according to the image processing method according to the second embodiment, when an input image 200 as shown in a section (a) in FIG. 11 is input into the image processing apparatus 2 from the outside (Step S101), the base depth creating unit 21 analyzes the input image 200, and creates a base depth 240 as shown in a section (h) in FIG. 11 based on a result of the analysis (Step S202). After that, according to the second embodiment, through processes similar to the processes at Steps S103 to S110 in FIG. 3, a created depth map 250 is output to a certain external device, such as a display device (See a section (b) in FIG. 11 to a section (g) in FIG. 11, and a section (i) in FIG. 11). Accordingly, the image processing method of creating the depth map 250 about the input image 200 is finished.

By configuring and operating in this way as described above, according to the second embodiment, the base depth 240 appropriate to the spatial structure of the input image 200 is created. Accordingly, a structure of depth more similar to the actual depth structure in the input image 200 can be used. As a result, a structure (depth map) with more accurate depth can be created from a two-dimensional image. The other configurations, operations, and effects are similar to those according to the first embodiment and its modification, therefore detailed explanations are omitted here.

### Third Embodiment

Next, an image processing apparatus, an image processing method, and a computer program product thereof according to a third embodiment are explained below in detail with reference to the drawings. In the following description, configurations similar to the first embodiment and its modification are assigned with the same reference numerals, and repeated explanations of them are omitted.

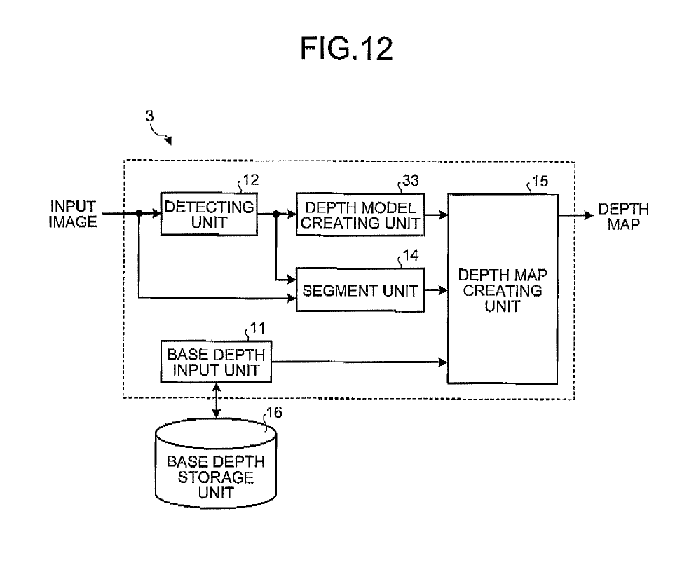

FIG. 12 is a schematic configuration diagram of an image processing apparatus 3 according to the third embodiment. As it is obvious by comparing FIG. 12 and FIG. 1, the image processing apparatus 3 (FIG. 12) includes a configuration similar to the image processing apparatus 1 (FIG. 1). However, in the image processing apparatus 3, the selecting unit 13 in the image processing apparatus 1 is replaced with a depth model creating unit 33, and the depth model storage unit 17 is omitted.

The depth model creating unit 33 creates a depth model about the object 101 from the position and the area (shape and size) of the object 101 detected by the detecting unit 12. The depth model to be created can be variously changed in form to a hemisphere (including one with an oval cross-section), a semicircular column, a half cone, a rectangular parallelepiped, a polygonal pyramid, or the like. A shape of the depth model is preferably a shape that can be easily obtained by a function. The depth model creating unit 33 selects a function to be used when creating a depth model, for example, based on the shape of the object 101, and adjusts the shape and the size to be obtained by the function based on the size of the object 101. The depth model created in this way is input into the depth map creating unit 15, and to be used for creation of the depth map, similarly to the first and the second embodiments and its modification.

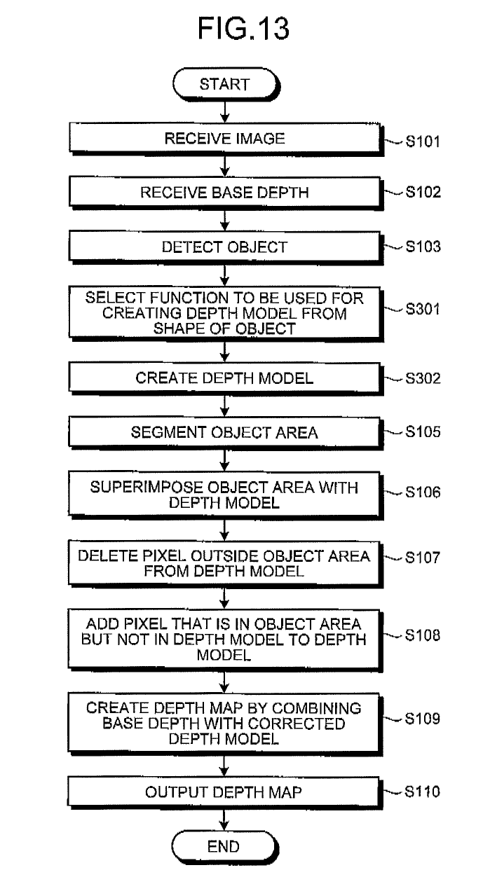

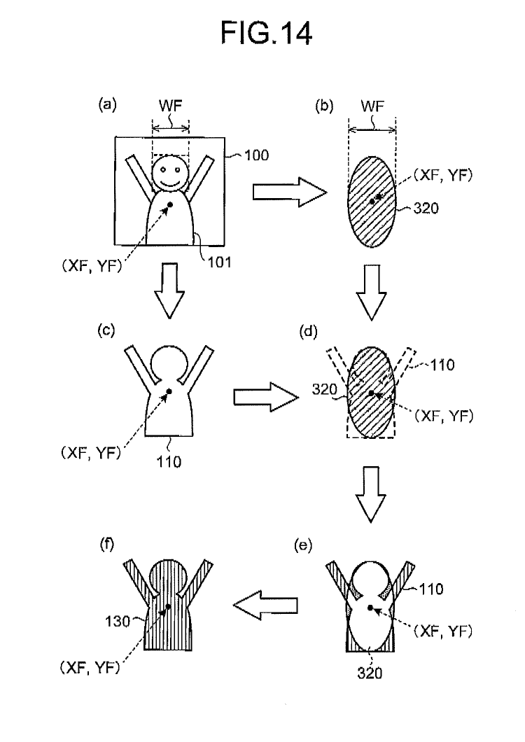

Next, a flow of an image processing method according to the third embodiment is explained below in detail with reference to the drawings. FIG. 13 is a flowchart that depicts a flow in outline of an image processing method according to the third embodiment. FIG. 14 is a schematic diagram that depicts a flow when creating a depth model about an object in an input image. In the following explanation, a configuration similar to the first or the second embodiment, or its modification, is appropriately compared and chosen.

As shown in FIG. 13, according to the image processing method according to the third embodiment, through processes similar to the processes shown at Steps S101 to S103 in FIG. 3, the base depth 140 and the object area 110 are acquired (see a section (a) in FIG. 14 and a section (c) in FIG. 14). According to the third embodiment, the position of the object 101 detected at Step S103 is preferably such that the barycentric coordinates or the central coordinates of the object 101 is at the reference coordinates (XF, YF). The width WF of the object 101 is preferably the width of a main part of the object 101.

Subsequently, according to the third embodiment, a function to be used for creating a depth model from the shape of the object 101 detected by the detecting unit 12 is selected (Step S301); and then a value appropriate to the size of the object 101 is set into the selected function, and model calculation is performed, so that a depth model 320 as shown in the section (b) in FIG. 14 is created (Step S302). After that, through processes similar to the processes shown at Steps S105 to S109 in FIG. 3, the corrected depth model 130 is created by correcting the depth model 320 (see a section (d) in FIG. 14 to a section (f) in FIG. 14), and the depth map 150 is created by combining the corrected depth model 130 with the base depth 140. Moreover, the created depth map 150 is output to a certain external device, such as a display device, similarly to Step S110 in FIG. 3. Accordingly, the image processing method of creating the depth map 150 about the input image 100 is finished.

By configuring and operating in this way as described above, according to the third embodiment, a need for preliminarily preparing depth models corresponding to various objects is omitted, so that a storage area to be provided in the image processing apparatus 3 can be reduced. The other configurations, operations, and effects are similar to those according to the first or the second embodiment, or its modification, therefore detailed explanations are omitted here.

The image processing apparatus and the image processing method according to the embodiments described above can be implemented by software or hardware. When implemented by software, the image processing apparatus and the image processing method are implemented by reading and executing a predetermined computer program with an information processor, such as a Central Processing Unit (CPU). The predetermined computer program can be recorded on a recording medium, such as a Compact Disk Read Only Memory (CD-ROM), a Digital Versatile Disk-ROM (DVD-ROM), or a flash memory, or can be recorded on a recording device connected to a network. The information processor reads or downloads the predetermined computer program and executes it.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying aims and their equivalents are intended to cover such forms or modifications as would fall within the scope and spirit of the inventions.

What is claimed is:

1. An image processing apparatus comprising:
a detecting unit configured to detect at least one object included in an image;
a selecting unit configured to select a depth model to be a base of information about depth of the object in accordance with a property of the object;
a segment unit configured to segment an area of the object detected from the image; and
a depth map creating unit configured to create a depth map representing a depth of the image, wherein
the depth map creating unit arranges the depth model at a position on the depth map corresponding to a position of the segmented area of the object in the image, compares an area of the depth model and the area of the object, and gives a corrected depth value to a position not superimposed on other.

2. The image processing apparatus according to claim 1, wherein when the area of the object includes a first area that is not included in the area of the depth model, the depth map creating unit gives the depth value to a not-superimposed position corresponding to the first area on the depth map, by using information about depth of a position in the depth model in a vicinity of the not-superimposed position.

3. The image processing apparatus according to claim 2, wherein the depth value is a depth value of a pixel in the depth model nearest to the not-superimposed position.

4. The image processing apparatus according to claim 2, wherein the depth value is an average of a depth value of a pixel in the depth model nearest to the not-superimposed position and depth values of a plurality of pixels around the pixel.

5. The image processing apparatus according to claim 2, wherein the depth value is a farthest value among a depth value of a pixel in the depth model nearest to the not-superimposed position and depth values of a plurality of pixels around the pixel.

6. The image processing apparatus according to claim 2, wherein the depth value is a farthest value among depth values of pixels in the depth model.

7. The image processing apparatus according to claim 1, wherein when the area of the depth model includes a second area that is not included in the area of the object, the depth map creating unit deletes a depth value of a not-superimposed position corresponding to the second area on the depth map.

8. The image processing apparatus according to claim 1, wherein when the area of the depth model includes a second area that is not included in the area of the object, the depth map creating unit gives the depth value to a not-superimposed position corresponding to the second area on the depth map, by using information about depth of a position in a vicinity of the not-superimposed position and outside the area of the object.

9. The image processing apparatus according to claim 1, wherein
the detecting unit detects at least a shape of a person from the image as the object,
the selecting unit selects the depth model in accordance with the shape of the person that is detected by the detecting unit from a group of preliminarily-registered depth models of person, and
the segment unit segments an area of the person from the image as the area of the object.

10. The image processing apparatus according to claim 1, wherein when adding information about depth to an area in the area of the object and outside the depth'model, the information about depth to be added is information indicating a farthest position in the depth model.

11. The image processing apparatus according to claim 1, further comprising a base depth creating unit configured to create a base depth to be added to the image as a base of information about depth of the image, wherein
the base depth creating unit creates the base depth to be located at a position farther than the depth model.

12. The image processing apparatus according to claim 1, further comprising a base depth creating unit configured to create a base depth to be added to the image as a base of information about depth of the image, wherein
the base depth creating unit creates the base depth whose depth is farthest.

13. An image processing method comprising:
detecting at least one object included in an image;
selecting a depth model to be a base of information about depth of the object in accordance with a property of the object;
segmenting an area of the object detected from the image; and
creating a depth map representing a depth of the image, wherein
the creating includes
arranging the depth model at a position on the depth map corresponding to a position of the segmented area of the object in the image,
comparing an area of the depth model and the area of the object, and
giving a corrected depth value to a position not superimposed on other.

14. A computer program product comprising a non-transitory computer-readable medium having programmed instructions, wherein the instructions, when executed by a computer, cause the computer to execute:
detecting at least one object included in an image;
selecting a depth model to be a base of information about depth of the object in accordance with a property of the object;
segmenting an area of the object detected from the image; and
creating a depth map representing a depth of the image, wherein
the creating includes
arranging the depth model at a position on the depth map corresponding to a position of the segmented area of the object detected in the image,
comparing an area of the depth model and the area of the object, and
giving a corrected depth value to a position not superimposed on other.
